(19) United States
(12) Patent Application Publication
(10) Pub. No.: US 2009/0135082 A1
(43) Pub. Date: May 28, 2009

(54) ANTENNA CARRIER FOR SUPPORTING A RADIATOR AND DEVICE THEREOF

(76) Inventor: Kai-Chung Hou, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/209,195

(22) Filed: Sep. 11, 2008

(30) Foreign Application Priority Data
Nov. 23, 2007 (TW) 096144375

(51) Int. Cl. H01Q 1/12

(52) U.S. Cl. 343/878

(57) ABSTRACT

An antenna carrier includes a first carrier block and a second carrier block. A radiator of the antenna carrier includes a first radiation block and a second radiation block. The first carrier block is disposed at a position corresponding to the first radiation block of the radiator. The first carrier block is made of material having a first dielectric constant. The second carrier block is disposed at a position corresponding to the second radiation block of the radiator and is connected to the first carrier block. The second carrier block is made of material having a second dielectric constant. The second dielectric constant is different from the first dielectric constant.

### BACKGROUND OF THE INVENTION

1. Field of the Invention

The present invention relates to an antenna carrier and a device thereof, and more specifically, to an antenna carrier for supporting a radiator and a device thereof.

2. Description of the Prior Art

An antenna is a component for performing electromagnetic transformation on radio transceivers. In general, an antenna is composed of a radiator and an antenna carrier. The radiator is a metal piece having a specific structure for transmitting and receiving electromagnetic waves. The antenna carrier is used for supporting and fixing the radiator. The antenna utilizes resonant currents generated from the radiator to transmit and receive radio waves. Therefore, the length of the radiator can affect its transmitting/receiving frequency range. Furthermore, radio signals input to the antenna and output from the antenna are implemented by the connection of a feeding end of the antenna and a cable.

With improvement of communication technology, antennas are used in many fields. The most representative example is to install antennas in communication apparatuses, such as mobile phones and Bluetooth wireless devices, so as to transmit and receive radio signals. However, one of the greatest challenges is to minimize the size of an antenna due to limited spaces in communication apparatuses. A common method is to use material having a high dielectric constant to fabricate an antenna carrier. When a radiator is carried by an antenna carrier made of material having a high dielectric constant instead of being carried by an antenna carrier made of material having a low dielectric constant, the frequency that the radiator can transmit and receive is reduced due to the high dielectric constant characteristic of the antenna carrier. Therefore, the wavelength of the radio signals that the radiator can transmit and receive can be increased accordingly. In this situation, the wavelength of the radio wave that the radiator can transmit and receive will still keep unchanged even if the size of the radiator is reduced. For example, when an antenna carrier in a communication apparatus is made of ceramic material (the dielectric constant is about 1000˜3000) instead of being made of plastic material (the dielectric constant is about 4˜10), such as GPS (Global Positioning System) antenna, the size of the antenna can be reduced efficiently.

However, several problems occur when an antenna carrier is made of ceramic material. The problems are listed as follows.

1. Ceramic material is heavy. The weight of ceramic material is about 5 to 10 times the weight of plastic material, which increases the overall weight of the antenna.

2. Ceramic material is hard and brittle, which makes mechanical design of the antenna difficult.

3. Ceramic material needs to be sintered to form an antenna carrier, which results in a lower yield and is more costly than an antenna carrier injected with plastic.

### SUMMARY OF THE INVENTION

The present invention provides an antenna carrier for supporting a radiator, the radiator comprising a first radiation block and a second radiation block, the antenna carrier comprising a first carrier block disposed at a position corresponding to the first radiation block of the radiator and made of material having a first dielectric constant; and a second carrier block disposed at a position corresponding to the second radiation block of the radiator and connected to the first carrier block, the second carrier block being made of material having a second dielectric constant that is different from the first dielectric constant.

The present invention further provides an antenna composed of material having different dielectric constants comprising a radiator comprising a first radiation block and a second radiation block; and an antenna carrier for supporting the radiator, the antenna carrier comprising a first carrier block disposed at a position corresponding to the first radiation block of the radiator and made of material having a first dielectric constant; and a second carrier block disposed at a position corresponding to the second radiation block of the radiator and connected to the first carrier block, the second carrier block being made of material having a second dielectric constant that is different from the first dielectric constant.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an exploded diagram of an antenna according to the present invention.

FIG. 2 is an assembly diagram of the antenna in FIG. 1.

FIG. 3 is a procedure diagram of the antenna in a double injection manner according to the present invention.

### DETAILED DESCRIPTION

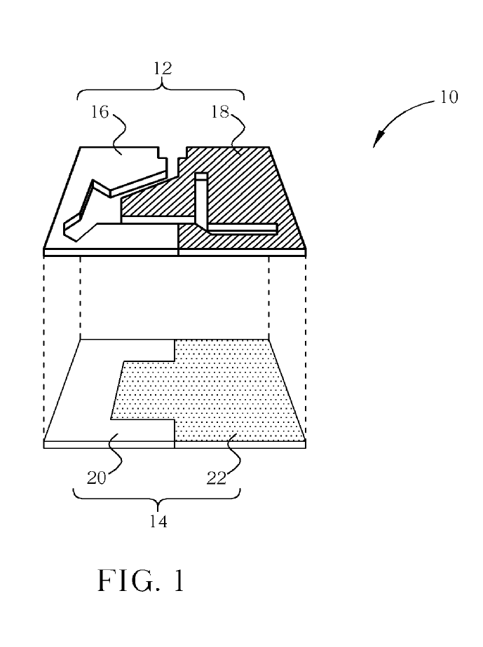

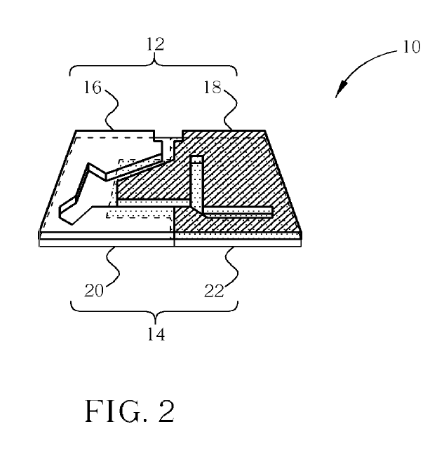

Please refer to FIG. 1 and FIG. 2. FIG. 1 is an exploded diagram of an antenna 10 according to the present invention. FIG. 2 is an assembly diagram of the antenna 10 in FIG. 1. The antenna 10 comprises a radiator 12 and an antenna carrier 14. The radiator 12 comprises a first radiation block 16 and a second radiation block 18. The antenna carrier 14 is used for supporting the radiator 12. The antenna carrier 14 comprises a first carrier block 20 and a second carrier block 22. The first carrier block 20 is disposed at a position corresponding to the first radiation block 16 of the radiator 12 and is made of material having a first dielectric constant, such as material mixed with plastics and ceramics or ceramic material. The second carrier block 22 is disposed at a position corresponding to the second radiation block 18 of the radiator 12 and connected to the first carrier block 20. The second carrier block 22 is made of material having a second dielectric constant that is different from the first dielectric constant, such as plastic material.

More detailed description for the molding process of the first carrier block 20 and the second carrier block 22 are provided as follows. Preferably, the first carrier block 20 and the second carrier block 22 are connected in a double injection manner. The principle of injection molding is described as follows. The first step is to add fixed quantity of plastic particles into a feeding funnel periodically and then send the plastic particles into a heating pipe so as to melt the plastic particles. The second step is to use a piston to push the melted plastic particles to pass through a nozzle and then inject them into a mold by the nozzle. After the mold is filled with the melted plastic particles, a cooling system is utilized to solidify the melted plastic particles so as to form a finished product. The final step is to open the mold to draw out the finished product when temperature inside the mold is decreased down to an appropriate temperature. Furthermore, there is another type of injection molding called “double injection”. The “double injection” is termed “double” because an extra feeding funnel, an extra heating pipe, and an improved nozzle are assembled into a traditional injection molding machine. Therefore, in a corresponding injection molding process, melted plastic particles are injected into a mold through two different pipes simultaneously or periodically so as to mix two kinds of compatible high-polymer plastic material.

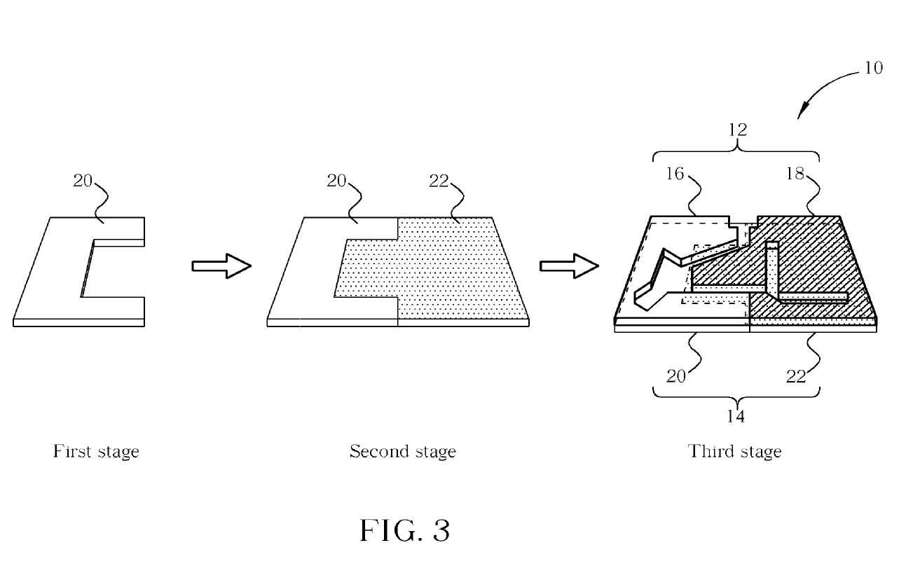

The present invention utilizes the said molding process to form and assemble the first carrier block 20 and the second carrier block 22. The first carrier block 20 is made of plastic and ceramic material. The second carrier block 22 is made of plastic material. The material of the first carrier block 20 and the second carrier block 22 is not limited to the aforementioned material. That is to say, the material of the first carrier block 20 and the second carrier block 22 can be interchanged. Please refer to FIG. 3. FIG. 3 is a process diagram of the antenna 10 in a double injection manner according to the present invention. First, the first carrier block 20 is formed in a mold through a first stage (the first injection). Next, the second carrier block 22 is formed in the mold through a second stage (the second injection) and is connected to the first carrier block 20. Finally, after the first carrier block 20 and the second carrier block 22 are connected to form the antenna carrier 14, the radiator 12 and the antenna carrier 14 are assembled to form the antenna 10 through a third stage. That is to say, the first radiation block 16 of the radiator 12 is disposed at a position corresponding to the first carrier block 20, and the second radiation block 18 of the radiator 12 is disposed at a position corresponding to the second carrier block 22. In such a manner, the size of the antenna 10 can be reduced accordingly. For example, if the first carrier block 20 is created by a mixture of 50 weight percent plastic material and 50 weight percent ceramic material, the size of the antenna 10 can be reduced by up to 30 percent. In addition, the antenna carrier 14 is composed of the first carrier block 20 having the first dielectric constant and the second carrier block 22 having the second dielectric constant, so the antenna carrier 14 can have multiple dielectric constants. Therefore, design in radio frequency range of the antenna 10 can be more flexible. It should be noted that the antenna carrier 14 can be also assembled by more than two carrier blocks having different dielectric constants respectively. The related injection molding process is similar to the said process, so the detailed description is omitted herein. Furthermore, mixing percentage of plastic and ceramic material is not limited to the said mixing percentage, too. It can be adjusted based on practical demands.

Another embodiment of the present invention involves connecting the first carrier block 20 and the second carrier block 22 in an insert molding manner. The difference between “insert molding” and “double injection” is described in the following. “Insert molding” involves disposing an insert into a mold in advance. The next step is to add fixed quantity of plastic particles into a feeding funnel periodically and then send the plastic particles into a heating pipe to melt the plastic particles. The second step is to use a piston to push the melted plastic particles to pass through a nozzle, inject the melted plastic particles into the mold by the nozzle, and then connect the melted plastic particles to the insert. In this embodiment, the first carrier block 20 is made of ceramic material or plastic and ceramic material. The second carrier block 22 is made of plastic material. The material of the first carrier block 20 and the second carrier block 22 is not limited to the aforementioned material. That is to say, the material of the first carrier block 20 and the second carrier block 22 are interchangeable. The method for connecting the first carrier block 20 and the second carrier block 22 in an insert molding manner is described as follows. First, the said material of the first carrier block 20 (ceramic material or plastic and ceramic material) is sintered to form the first carrier block 20. Next, the first carrier block 20 is disposed into a mold. Subsequently, the second carrier block 22 is formed in the mold through an injection molding process and is connected to the first carrier block 20 at the same time. After the first carrier block 20 and the second carrier block 22 are connected so as to form the antenna carrier 14, the radiator 12 and the antenna carrier 14 are assembled into the antenna 10. That is to say, the first radiation block 16 of the radiator 12 is disposed at a position corresponding to the first carrier block 20, and the second radiation block 18 of the radiator 12 is disposed at a position corresponding to the second carrier block 22. In such a manner, the size of the antenna 10 can be reduced due to the high dielectric constant characteristic of the first carrier block 20, and the weight of the antenna carrier 14 can be lighter than that of an antenna carrier made of ceramic material since the antenna carrier 14 is assembled by the first carrier block 20 and the second carrier block 22. In addition, the antenna carrier 14 is composed of the first carrier block 20 having the first dielectric constant and the second carrier block 22 having the second dielectric constant, so the antenna carrier 14 can have multiple dielectric constants. Therefore, design in radio frequency range of the antenna 10 can be more flexible.

In summary, compared with the prior art utilizing ceramic material to reduce a size of an antenna, the present invention utilizes the said injection molding process to fabricate an antenna carrier having multiple dielectric constants. Therefore, not only the size of the antenna can be reduced, but the weight and cost of the antenna carrier can also be decreased.

Those skilled in the art will readily observe that numerous modifications and alterations of the device and method may be made while retaining the teachings of the invention.

What is claimed is:

1. An antenna carrier for supporting a radiator, the radiator comprising a first radiation block and a second radiation block, the antenna carrier comprising:
a first carrier block disposed at a position corresponding to the first radiation block of the radiator and made of material having a first dielectric constant; and
a second carrier block disposed at a position corresponding to the second radiation block of the radiator and connected to the first carrier block, the second carrier block being made of material having a second dielectric constant that is different from the first dielectric constant.

2. The antenna carrier of claim 1, wherein the first carrier block and the second carrier block are connected in an injection molding manner.

3. The antenna carrier of claim 2, wherein the first carrier block and the second carrier block are connected in an insert molding manner.

4. The antenna carrier of claim 3, wherein the first carrier block is made of plastic and ceramic material or ceramic material.

5. The antenna carrier of claim 3, wherein the second carrier block is made of plastic material.

6. The antenna carrier of claim 2, wherein the first carrier block and the second carrier block are connected in a double injection manner.

7. The antenna carrier of claim 6, wherein the first carrier block is made of plastic and ceramic material.

8. The antenna carrier of claim 6, wherein the second carrier block is made of plastic material.

9. An antenna composed of material having different dielectric constants comprising:
a radiator comprising a first radiation block and a second radiation block; and
an antenna carrier for supporting the radiator, the antenna carrier comprising:
a first carrier block disposed at a position corresponding to the first radiation block of the radiator and made of material having a first dielectric constant; and
a second carrier block disposed at a position corresponding to the second radiation block of the radiator and connected to the first carrier block, the second carrier block being made of material having a second dielectric constant that is different from the first dielectric constant.

10. The antenna of claim 9, wherein the first carrier block and the second carrier block are connected in an injection molding manner.

11. The antenna of claim 10, wherein the first carrier block and the second carrier block are connected in an insert molding manner.

12. The antenna of claim 11, wherein the first carrier block is composed of plastic and ceramic material or ceramic material.

13. The antenna of claim 11, wherein the second carrier block is made of plastic material.

14. The antenna of claim 10, wherein the first carrier block and the second carrier block are connected in a double injection manner.

15. The antenna of claim 14, wherein the first carrier block is made of plastic and ceramic material.

16. The antenna of claim 14, wherein the second carrier block is made of plastic material.
